(19) United States
(12) Patent Application Publication
(10) Pub. No.: US 2025/0026212 A1
(43) Pub. Date: Jan. 23, 2025

(54) CHARGING STATION, ESPECIALLY FOR ELECTRIC VEHICLES

(71) Applicant: ads-tec Energy GmbH, Nürtingen (DE)

(72) Inventor: Thomas SPEIDEL, Markgröningen (DE)

(21) Appl. No.: 18/746,232

(22) Filed: Jun. 18, 2024

(30) Foreign Application Priority Data
Jul. 20, 2023 (DE) 102023119224.8

(51) Int. Cl. B60L 53/16; H01R 31/06; H02J 7/00

(52) U.S. Cl. CPC B60L 53/16; H02J 7/0042; H01R 31/06

(57) ABSTRACT

The invention relates to a charging station, in particular for electric vehicles, with at least one charging point comprising a charging plug for electrical connection to an electrical device to be charged, and with a plug adapter, wherein the plug adapter is non-detachably fixed to the charging plug.

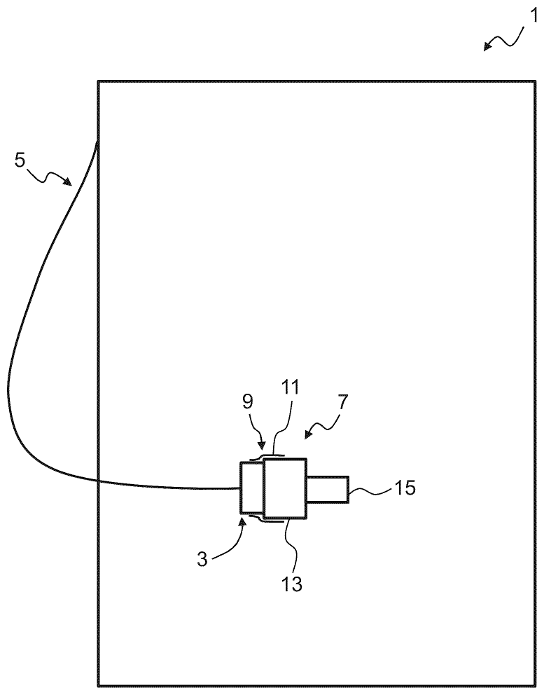

The invention relates to a charging station, especially for electric vehicles.

Various standards of plugs and sockets have become established in different regions for charging electrical devices, in particular electric vehicles at charging stations. In particular, there are standards that only allow comparatively slow charging by means of alternating current, and combination standards in which the charging option via alternating current and also a comparatively faster charging option via direct current are provided in a common plug. In addition, fast charging stations typically use the contact pattern of the AC plug to exchange information with a device to be charged, while the DC contacts are used for fast charging. Such combination standards can thus comprise separate contact systems for direct current on the one hand and alternating current on the other, such as CCS1 or CCS2, or they can use an identical contact system for direct current and alternating current, such as NACS. At a conventional charging station, in particular at fast charging stations, a certain type of plug is typically permanently installed, so that electrical devices such as electric vehicles that do not comprise a charging socket suitable for this type of plug cannot be charged. In principle, plug adapters have also become known that can be used to adapt one type of plug to another type of socket, but such plug adapters must be carried around by the user of the electrical device, for example in an electric vehicle, which is cumbersome. In certain areas of the world, different types of plugs have become the dominant species. For example, the CCS1 standard currently dominates in the USA, while the CCS2 standard dominates in Europe. If the relative share of other standards increases in the respective regions, or simply to provide users of other standards with greater convenience, there will be a need to convert at least a certain proportion of existing charging stations. However, changing the originally installed charging plug is time-consuming and expensive.

The invention is therefore based on the task of creating a charging station—in particular for electric vehicles—wherein the disadvantages mentioned are at least reduced, preferably do not occur.

The Task is Solved by Providing the Present Technical Teaching, in Particular the Teaching of the Independent Claims and the Embodiments Disclosed in the Dependent Claims and the Description.

The task is solved in particular by providing a charging station, in particular for electric vehicles, which comprises at least one charging point comprising at least one charging plug for electrical connection to an electrical device to be charged, in particular an electric vehicle. The charging station also comprises a plug adapter which is non-detachably firmly connected to the charging plug. Advantageously, an existing charging station can be upgraded in this way for other charging sockets that are not compatible with the charging plug, so that a user of an electrical device to be charged no longer needs to carry a plug adapter with them. In particular, the solution proposed here allows existing charging stations to be retrofitted easily, quickly and cost-effectively by permanently connecting the plug adapter to the original charging plug of the charging station. By permanently connecting the plug adapter to the charging plug, unauthorized removal of the plug adapter is also prevented.

In the context of the present technical teaching, “non-detachably firmly connected” is understood in particular to mean that the plug adapter is connected to the charging plug in such a way that it cannot be detached from the charging plug without causing damage or destruction.

In one embodiment, the charging station comprises a plurality of charging points, wherein a charging plug is assigned to each charging point. In one embodiment, a plug adapter is non-detachably firmly connected to each of the charging plugs. In another embodiment, only a sub-number of the charging plugs has a plug adapter non-detachably firmly connected to it, wherein the sub-number is smaller than the total number of charging plugs; in particular, in one embodiment, a plug adapter is non-detachably firmly connected to only one charging plug of exactly one charging point. In this way, a charging station can have several different types of plug connectors that are compatible with different charging sockets. This makes the charging station particularly flexible for different users.

In electrical engineering, a charging station is any device or electrical system, in particular stationary or mobile, which is used to supply energy to mobile battery-powered electrical devices, appliances, machines or motor vehicles by simply plugging them in without having to remove the traction energy storage device-such as the traction battery of an electric car. Charging stations for electric cars are sometimes also referred to as “current charging stations” and can comprise several charging points. High performance charging systems (HPC systems) such as the combined charging system (CCS), which is widely used in Europe, are known in particular. With generic direct current charging, direct current from the charging station is fed directly into the vehicle's battery and supplied by a powerful rectifier, preferably from the charging station, from the power grid or from large buffer accumulators at solar charging stations, for example. There is a battery management system in the vehicle that communicates directly or indirectly with the charging station in order to adjust the current and voltage or to terminate the process when a predetermined capacity limit is reached. Power electronics are usually located in the charging station. As the direct current connections of the charging station are connected directly to the corresponding connections of the traction battery-without going via an AC/DC converter of the vehicle-high charging currents can be transmitted with low losses, which enables short charging times.

In one embodiment, the charging station is configured as a charging pillar. In particular, the charging station comprises at least one charging point, in particular exactly one charging point or exactly two charging points.

In particular, the charging station is configured as a fast charging station. In one embodiment, the charging station is configured as a battery-supported charging station, in particular as a battery-supported fast charging station.

According to a further development of the invention, it is provided that the plug adapter is materially bonded to the charging plug. Alternatively or additionally, it is provided that the plug adapter is connected to the charging plug in a form-fit manner. Alternatively or additionally, it is provided that the plug adapter is connected to the charging plug in a force-fit manner. In any of these ways, a firm, stable and non-detachable connection of the plug adapter to the charging plug can be advantageously established.

According to a further development of the invention, it is provided that the plug adapter is glued to the charging plug. Alternatively or additionally, it is provided that the plug adapter is welded to the charging plug, in particular by plastic welding. Advantageously, a connection between the plug adapter and the charging plug that is as firm as it is particularly tight, in particular moisture-proof, can be produced in this way.

According to a further development of the invention, it is provided that at least in a transition area between the charging plug and the plug adapter an encasement reaching around the transition area is arranged. Advantageously, the transition area and thus in particular the connection area between the charging plug and the plug adapter can be protected from mechanical influences and/or penetrating moisture by means of the encasement. This also increases the stability and security of the connection.

According to a further development of the invention, it is provided that the encasement comprises a shrink sleeve or consists of a shrink sleeve. This embodiment of the encasement is advantageously as simple and cost-effective as it is tight, in particular moisture-tight.

According to a further development of the invention, it is provided that the plug adapter is connected to the charging plug by means of the encasement, in particular by means of the shrink sleeve. Advantageously, the encasement can fulfill two functions in this way, namely to simultaneously establish the connection between the plug adapter and the charging plug and to protect the connection area, in particular from mechanical influences and/or penetrating moisture.

According to a further development of the invention, it is provided that the plug adapter comprises a socket part and a plug part, wherein the charging plug is inserted into the socket part, wherein the plug part is adapted to cooperate with a charging socket of an electrical device to be charged, and wherein the socket part comprises a plug connection type which is selected from a group consisting of: CCS1, CCS2, Type 1 or J1772, GB/T, Type 2 or Mennekes, CHAdeMO, and NACS, wherein the plug part has another connector type selected from the same group consisting of: CCS1, CCS2, Type 1 or J1772, GB/T, Type 2 or Mennekes, CHAdeMO, and NACS.

In one embodiment, the socket part comprises the connector type CCS1 and the plug part comprises the connector type NACS. In another embodiment, the socket part comprises the plug connection type NACS and the plug part comprises the plug connection type CCS1. In another embodiment, the socket part comprises the plug connection type CCS2 and the plug part comprises the plug connection type NACS. In another embodiment, the socket part comprises the plug connection type NACS and the plug part comprises the plug connection type CCS2. In further embodiments, all conceivable combinations of existing or future connector types are possible.

In one embodiment, the charging plug is inserted into the socket part and is non-detachably firmly connected to the socket part.

The invention is explained in more detail below with reference to the drawing. Thereby shows the only:

FIGURE a schematic representation of an embodiment example of a charging station with a plug adapter.

The only Fig. shows a schematic representation of an embodiment example of a charging station 1.

The charging station 1, which is in particular adapted to charge a traction energy storage device of an electric vehicle, comprises at least one charging point 5 with a charging plug 3 for electrical connection to an electrical device to be charged—in particular to the electric vehicle. In addition, the charging station 1 comprises a plug adapter 7, which is non-detachably firmly connected to the charging plug 3.

The charging station 1 may comprise a plurality of charging points 5, wherein in particular a charging plug 3 may be assigned to each charging point 5. It is possible that a plug adapter 7 is connected to a smaller number of charging plugs 3 than the total number of charging plugs 3. In particular, a plug adapter 7 can be connected to exactly one charging plug 3 of a plurality of charging plugs 3. However, it is also possible that one plug adapter 7 is connected to each charging plug 3.

The plug adapter 7 is preferably materially bonded to the charging plug 3. Alternatively or additionally, the plug adapter 7 is connected to the charging plug 3 in a form-fit manner. Alternatively or additionally, the plug adapter 7 is force-fit connected to the charging plug 3.

It is particularly preferred that the plug adapter 7 is glued or welded to the charging plug 3, in particular by plastic welding.

Preferably, at least in a transition area 9 between the charging plug 3 and the plug adapter 7, an encasement 11 reaching around the transition area 9 is arranged, in particular to protect the transition area 9 and thus, in particular, a connection area between the charging plug 3 and the plug adapter 7 from mechanical influences and/or penetrating moisture. Preferably, the encasement 11 comprises a shrink sleeve or consists of a shrink sleeve.

In particular, it is possible for the plug adapter 7 to be connected to the charging plug 3 by means of the encasement 11, in particular by means of the shrink sleeve.

The plug adapter 7 comprises a socket part 13 and a plug part 15. The socket part 13 is adapted to interact with the charging plug 3. The plug part 15 is adapted to interact with a charging socket of the electrical device to be charged, in particular of the electric vehicle.

Preferably, the socket part 13 comprises a connector type selected from a group consisting of: CCS1, CCS2, Type 1 or J1772, GB/T, Type 2 or Mennekes, CHAdeMO, and NACS. The plug part 15 comprises another connector type selected from the same group.

1. A charging station, in particular for electric vehicles, having at least one charging point comprising a charging plug for electrical connection to an electrical device to be charged, and having a plug adapter, wherein the plug adapter is non-detachably firmly connected to the charging plug.

2. The charging station according to claim 1, wherein the plug adapter is connected to the charging plug in a materially bonded, form-fit and/or force-fit manner.

3. The charging station according to claim 1, wherein the plug adapter is glued and/or welded to the charging plug.

4. The charging station according to claim 1, wherein at least in a transition area (9) between the charging plug and the plug adapter an encasement reaching around the transition area (9) is arranged.

5. The charging station according to claim 4, wherein the encasement comprises a shrink sleeve or consists of a shrink sleeve.

6. The charging station according to claim 4, wherein the plug adapter is connected to the charging plug by means of the encasement, in particular by means of the shrink sleeve.

7. The charging station according to claim 1, wherein the plug adapter comprises a socket part and a plug part, wherein the charging plug is plugged into the socket part, wherein the plug part is adapted to cooperate with a charging socket of an electrical device to be charged, and wherein the socket part comprises a plug connection type selected from a group consisting of: CCS1, CCS2, Type 1 or J1772, GB/T, Type 2 or Mennekes, CHAdeMO, and NACS, wherein the plug part comprises another connector type selected from the same group.
